(19) United States
(12) Patent Application Publication
(10) Pub. No.: US 2006/0127587 A1
(43) Pub. Date: Jun. 15, 2006

(54) Organic silicate polymer and insulation film comprising the same

(76) Inventors: Jung-won Kang, Seoul (KR); Myung-Sun Moon, Daejeon-city (KR); Min-Jin Ko, Daejeon-city (KR); Gwi-Gwon Kang, Seoul (KR); Dong-Seok Shin, Seoul (KR); Hye-Yeong Nam, Chungeheongbuk-do (KR); Young-Duk Kim, Daejeon-city (KR); Bum-Gyu Choi, Daejeon-city (KR); Byung-Ro Kim, Daejeon-city (KR); Sang-Min Park, Daejeon-city (KR)

Correspondence Address: MCKENNA LONG & ALDRIDGE LLP, 1900 K STREET, NW, WASHINGTON, DC, 20006, US

(21) Appl. No.: 10/516,494

(22) PCT Filed: Jun. 27, 2003
(86) PCT No.: PCT/KR03/01271

§ 371 Date: Sep. 26, 2005

(30) Foreign Application Priority Data
Jun. 27, 2002 (KR) 10-2002-0036426

(51) Int. Cl. B05D 3/02; C08G 77/60; C07F 7/18

(52) U.S. Cl. 427/387; 106/287.13; 528/35

(57) ABSTRACT

The present invention relates to a composition for forming a low dielectric insulating film for a semiconductor device, particularly to an organosilicate polymer prepared by mixing a thermally decomposable organic silane compound that is capped with a silane compound at both its ends, and a common silane compound or silane oligomer, and then adding water and a catalyst to conduct hydrolysis and condensation, as well as to a coating composition for an insulating film for a semiconductor device comprising the same, a coating composition for an insulating film for a semiconductor device further comprising a pore-forming organic substance, a method for preparing an insulating film for a semiconductor device by coating the composition and curing, and a semiconductor device comprising a low dielectric insulating film prepared by the method. The organosilicate polymer prepared according to the present invention has superior thermal stability and mechanical strength; an insulating film-forming composition comprising the same can be used for an interlayer insulating film for low dielectric wiring that can contribute to a high speed semiconductor, reduce power consumption, and remarkably decrease cross-talk between metal wiring; and a film obtained by applying the composition to an insulating film has superior coating properties, inhibits phase-separation, can easily control minute pores because organic substances are thermally decomposed to form pores during a curing process, and has superior insulating properties and a remarkably decreased film density.

### BACKGROUND OF THE INVENTION

(a) Field of the Invention

The present invention relates to an organosilicate polymer having superior coating, mechanical, and dielectric properties, and more particularly to a method for preparing an organosilicate polymer having superior coating, mechanical, and dielectric properties and an organosilicate polymer prepared according to the above method, a dielectric insulating film for a semiconductor device wherein the above organosilicate polymer is coated and cured, and a semiconductor device comprising the same.

(b) Description of the Related Art

Recently, the line width of wiring interconnecting the inner parts of a device has rapidly decreased as the integrity of semiconductor devices has increased, and a high density device using a circuit line width of 0.1 μm is expected to be developed around the year 2003.

Generally, the speed of a semiconductor device is proportional to a switching speed of a transistor and a transmission speed of signals, and the transmission speed of signals is determined by RC delay represented by the product of a resistance of wiring material and a capacitance of an interlayer insulating film. As the integrity of a semiconductor device increases, the line width of wiring interconnecting the inner parts of the device narrows, the thickness thereof thins, and length thereof increases in geometrical progression, and thus a speed on a high density chip is determined by RC delay thereon rather than by a switching speed. Accordingly, in order to manufacture a high speed chip, a conductor with low resistance and a low dielectric insulating material should be used. In addition, the use of a low dielectric material enables an increase in the speed of a semiconductor device, a decrease in power consumption, and a remarkable decrease in cross-talk between metal wiring.

Recently, IBM has marketed a test semiconductor product that uses copper wiring with high conductivity instead of aluminum wiring, and thus shows a performance improvement of 20% or more. However, it is difficult to commercialize a semiconductor device using a low dielectric material, particularly one having a dielectric constant of 2.5 or less, due to insufficient development of an appropriate material.

Most conventional interlayer insulating materials for a semiconductor such as an IC, LSI, etc. are SiO₂ having a dielectric constant of 4.0, and a low dielectric fluorine-doped silicate (F—SiO₂) is applied to some devices. However, F—SiO₂ becomes thermally unstable if the fluorine content is 6% or more, and thus it is difficult to lower the dielectric constant below 3.5. Recently, in order to solve this problem, various organic and inorganic polymers that have low polarities and are thermally stable have been suggested.

As organic polymers having low dielectric constants, a polyarylene ether resin and an aromatic hydrocarbon resin, etc. are known. Most of such organic polymers have dielectric constants of 3.2 to 2.6, and thus they have low glass transition temperatures, and they also have inferior mechanical properties and high linear expansion coefficients, compared to SiO₂. Such an organic polymer having a low thermal stability and elasticity and a high linear expansion coefficient may deteriorate reliability of a device.

Recently, in order to solve the thermal stability problem of an organic polymer, an organosilicate polymer using an alkoxysilane compound has come under development. This method is to hydrolyze and condensate an organosilane, and then form an organosilicate film through a curing process. As the organosilane, methyl or hydrogen silsesquioxane is thermally stable at 450° C. However, the polysilsesquioxane has a comparatively high dielectric constant of 2.7 or more, and insufficient mechanical properties.

The organic polymer, organosilicate polymer, etc. having dielectric constants of 2.5 to 3.0 are commercially used despite their various problems, and studies on ultra low dielectric materials having dielectric constants of 2.5 or less required in the future are under progress. As an ultra low dielectric material having a dielectric constant of 2.5 or less, a fluorine-containing resin and a porous film, etc. have been suggested, but a material having sufficient properties for an interlayer insulating film of an LSI has not yet been developed. Although the fluorine-containing resin has a low dielectric constant of approximately 2.0, its thermal decomposition temperature is 400° C. or less, which is not sufficient to withstand a current semiconductor process temperature. Therefore, a porous film wherein pores are incorporated into a low dielectric material having a dielectric constant of 2.5 to 3.0 has attracted attention. As a conventional method for forming a porous film, U.S. Pat. No. 5,700,844 has disclosed a method for forming a porous film by dispersing a polymer precursor and polymer particles, curing the polymer precursor, and then heating it at high temperature to remove the polymer particles. However, this method uses polymer particles for forming pores, and thus small pores of a few nanometers are difficult to form. In addition, a method for preparing a porous ultra dielectric substance by dispersing an organosilicate polymer and a thermally decomposable polymer, curing the organosilicate at a specific temperature to cause phase separation, and heating it at high temperature to remove the organic polymer has been proposed. According to this method, a degree of phase separation is determined by the interaction of hydroxyl functional groups of the organosilicate polymer and organic polymer, but since functional groups of the organosilicate polymer rapidly decrease due to condensation during drying and curing processes, it is difficult to control phase separation, and more seriously, an opaque film may be formed.

U.S. Pat. No. 6,126,733 has used a solvent with a high boiling point instead of an organic polymer for forming pores. According to this method, a high boiling point solvent is phase-separated into nano sizes during a curing process, and the high boiling point solvent is evaporated during a second curing process. However, this method has problems in that phase separation of the high boiling point solvent during gelling and film-forming processes are difficult to control.

### SUMMARY OF THE INVENTION

The present invention is made in consideration of the problems of the prior art, and it is an object of the present invention to provide a low dielectric material that can be used for a low dielectric wiring interlayer insulating film, which can contribute to high speed in a semiconductor device, reduce power consumption, and remarkably decrease cross-talk between metal wiring.

It is another object of the present invention to provide an organosilicate polymer comprising the above low dielectric material and a method for preparing the same, and a coating composition for forming an insulating film for a semiconductor device capable of easily forming pores using the same.

It is another object of the present invention to provide a method for preparing a low dielectric insulating film using the above coating composition that can easily form pores and has superior coating properties, and a semiconductor device comprising the low dielectric insulating film that can easily control minute pores and has superior insulating properties and a remarkably decreased film density.

In order to achieve these objects, the present invention provides a method for preparing an organosilicate polymer, which comprises the steps of mixing a thermally decomposable organic silane compound that is capped with silane compounds at both its ends, and a silane compound or silane oligomer, and adding water and a catalyst thereto to conduct hydrolysis and condensation.

The present invention also provides an organosilicate polymer prepared according to the above method.

The present invention also provides a coating composition for forming a low dielectric insulating film for a semiconductor device comprising an organosilicate polymer prepared according to the above method, and a low dielectric insulating film for a semiconductor wherein the above coating composition is coated and cured.

More particularly, the present invention provides a coating composition for forming an insulating film for a semiconductor device, which comprises:

a) an organosilicate polymer comprising

i) a thermally decomposable organic silane compound that is capped with silane compounds at both its ends, and

ii) a silane compound or silane oligomer; and

b) an organic solvent.

The present invention also provides a method for preparing a low dielectric insulating film for a semiconductor device, which comprises the steps of:

a) providing a solution of a coating composition for forming an insulating film comprising

i) an organosilicate polymer comprising a thermally decomposable organic silane compound that is capped with silane compounds at both its ends, and a silane compound or silane oligomer, and

ii) an organic solvent;

b) coating the a) solution on a substrate of a semiconductor device to form an insulating film; and

c) drying and curing the b) coated insulating film, and a semiconductor device comprising a low dielectric insulating film prepared according to the above method.

### DETAILED DESCRIPTION OF THE PREFERRED EMBODIMENTS

The present invention will now be explained in more detail.

The present inventors, in the course of studying a method for preparing an insulating film of low density capable of easily controlling the coating properties and minute pores, prepared a composition for forming an insulating film comprising an organosilicate polymer by mixing a thermally decomposable organic silane that is capped with silane compounds at both its ends, and a silane compound or silane oligomer in an organic solvent, and then adding water and a catalyst to conduct hydrolysis and condensation. As results, it was identified that a low dielectric film can be effectively prepared by inhibiting phase separation and forming pores by thermal decomposition of an organic substance during a curing process, and that the thus-prepared insulating film has easily controllable pores, superior insulating properties, and remarkably lowered film density. The present invention is based on the above discovery.

Generally, in a nanopore forming method using a pore-forming material, the degree of phase separation is determined by compatibility between a matrix resin and the pore-forming material. However, the number of functional groups in an organosilicate polymer decreases due to condensation during drying and curing processes, the matrix environment changes to make it difficult to precisely control the micro-environment, and phase separation may occur to deteriorate the coating properties. According to the present invention, a thermally decomposable organic silane compound that is capped with silane compounds at both its ends, and a silane compound or silane oligomer are hydrolyzed and condensed to improve compatibility, and the organic substance is thermally decomposed to form pores during a curing process, thereby effectively preparing a low dielectric insulating film.

The pore-forming method used in the present invention, which uses an organosilicate polymer comprising a thermally decomposable organic silane compound that is capped with silane compounds at both its ends is represented by the following Equation 1.
[Equation 1]

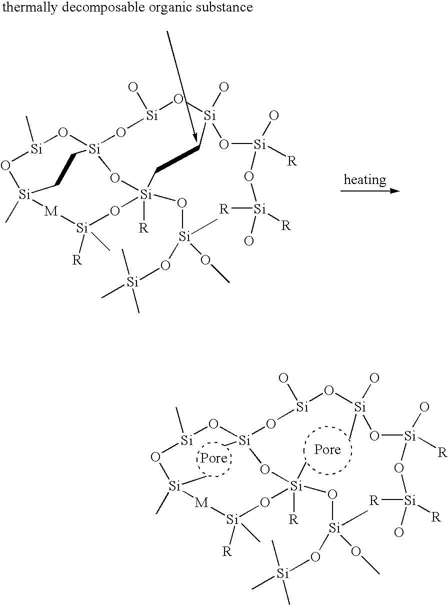

The organic substance that is covalently bonded to the silicon atom is selected from those capable of being thermally decomposed at 450° C. or less under a vacuum or inert gas atmosphere, and preferably those capable of being thermally decomposed at 400° C. If the thermally decomposable organic substance is capped with a silane compound at one end, compatibility may deteriorate depending on the kind of organic substance, and if there are too many chemical bonds between the organic substance and the silane compound, compatibility is superior but it cannot effectively lower the dielectric constant.

A method for preparing an organosilicate polymer comprising a thermally decomposable organic silane compound that is capped with silane compounds at both its ends is not specifically limited, and the polymer can be prepared by conducting hydrolysis and condensation of an organic silane compound that is capped with silane compounds at both its ends and that can be decomposed at 450° C. or less, and a silane compound or silane oligomer.

The thermally decomposable organic silane compound is preferably represented by the following Chemical Formula 1.
R¹ₚR²₃₋ₚSi-L—SiR³_{q}R⁴_{3-q} [Chemical Formula 1]

wherein

R¹ and R³ are independently a hydrogen, fluorine, aryl, vinyl, allyl, or substituted or unsubstituted linear or branched C1-4 alkyl;

R² and R⁴ are independently an acetoxy, hydroxy, or linear or branched C1-4 alkoxy;

L, which is an organic substance that can be thermally decomposed at 450° C. or less, is an organic oligomer or polymer consisting of an ether, ester, anhydride, carbonate, carbamate, acrylate, epoxy, isocyanate, or amide compound; and

p and q are respectively an integer of 0 to 2.

The molecular weight of the organic substance is not specifically limited, but if it is too low, pore size decreases and it is difficulty to effectively lower the dielectric constant, and if it is too high, compatibility and reactivity may deteriorate and pore size may increase. The molecular weight of the organic substance may be affected by the kind of molecular conformation thereof, and the weight average molecular weight is preferably 300 to 100,000 and more preferably 1000 to 100,000.

The thermally decomposable organic silane compound capped with silane compounds at both its ends, and the silane compound or silane oligomer used in hydrolysis and condensation, are silane compounds consisting of silicon, carbon, oxygen, and hydrogen. For examples, compounds selected from a group consisting of the compounds represented by the following Chemical Formula 2, Chemical Formula 3, or Chemical Formula 4 are used.
SiR⁵ₓR⁶₄₋ₓ [Chemical Formula 2]

wherein

R⁵ is independently a hydrogen, fluorine, aryl, vinyl, allyl, or substituted or unsubstituted linear or branched C1-4 alkyl;

R⁶ is independently an acetoxy, hydroxyl, or linear or branched C1-4 alkoxy; and

x is an integer of 0 to 2.
R⁷_{y}R⁸_{3-y}Si-M—SiR⁹_{z}R¹⁰_{3-z} [Chemical Formula 3]

wherein

R⁷ and R⁸ are independently a hydrogen, fluorine, aryl, vinyl, allyl, or substituted or unsubstituted linear or branched C1-4 alkyl;

R⁸ and R¹⁰ are independently an acetoxy, hydroxy, or linear or branched C1-4 alkoxy;

M is C1-6 alkylene or phenylene; and

y and z are respectively an integer of 0 to 2.

[Chemical Formula 4]

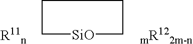

wherein

R¹¹ is independently a hydrogen, fluorine, aryl, vinyl, allyl, or substituted or unsubstituted linear or branched C1-4 alkyl;

R¹² is a hydroxy, or linear or branched C1-4 alkoxy; and

m and n are respectively an integer of 3 to 10.

According to the present invention, an organosilicate polymer with a specific molecular weight can be prepared by hydrolysis and condensation of a thermally decomposable organic silane compound that is capped with silane compounds at both its ends, represented by the above Chemical Formula 1, and a silane compound or silane oligomer selected from a group consisting of the compounds represented by the above Chemical Formulae 2, 3, or 4 after adding water and a catalyst in the presence of an organic solvent or under a bulk condition.

The mixing order of the silane compounds of the Chemical Formulae 1, 2, 3, and 4 used for preparing an organosilicate polymer is not specifically limited. The total amount can be mixed to conduct hydrolysis and condensation; or a specific amount can be mixed to conduct hydrolysis and condensation to a specific molecular weight and then the remaining amount can be added to further react.

The organic solvent is not specifically limited so long as it appropriately mixes a silane compound, water, and a catalyst, and it does not cause difficulty in hydrolysis and condensation. The examples include an aliphatic hydrocarbon solvent such as n-pentane, i-pentane, n-hexane, i-hexane, 2,2,4-trimethylpentane, cyclohexane, or methylcyclohexane, etc.; an aromatic hydrocarbon solvent such as benzene, toluene, xylene, trimethyl benzene, ethyl benzene, or methyl ethyl benzene, etc.; an alcohol solvent such as methylalcohol, ethylalcohol, n-propanol, i-propanol, n-butanol, i-butanol, sec-butanol, t-butanol, 4-methyl-2-pentanol, cyclohexanol, methylcyclohexanol, or glycerol, etc.; a ketone solvent such as acetone, methylethylketone, methyl-n-propylketone, methyl-n-butylketone, methyl-1-butylketone, diethylketone, cyclohexanone, methylcyclohexanone, or acetylacetone, etc.; an ether solvent such as tetrahydrofuran, 2-methyl tetrahydrofuran, ethylether, n-propylether, i-propylether, n-butylether, diglym, dioxin, dimethyldioxin, ethyleneglycolmonomethylether, ethyleneglycolmonoethylether, ethyleneglycol-n-propylether, ethyleneglycol dimethylether, ethyleneglycol diethylether, propyleneglycol monomethylether, propyleneglycol monoethylether, propyleneglycol monopropylether, propyleneglycol dimethylether, propyleneglycol diethylether, or propyleneglycol dipropylether, etc.; an ester solvent such as diethylcarbonate, methylacetate, ethylacetate, n-propylacetate, i-propylacetate, n-butylacetate, ethyllactate, ethyleneglycol monomethylether acetate, ethylglycol monoethylacetate, propyleneglycol monomethyletheracetate, propyleneglycol monoethyletheracetate, propyleneglycol monopropyletheracetate, ethyleneglycol diacetate, or propyleneglycol diacetate, etc.; and an amide solvent such as N-methylpyrrolidone, formamide, N-methylformamide, N-ethylformamide, N,N-dimethylformamide, N,N-diethylformamide, N-methylacetamide, N-ethylacetamide, N,N-diethylformamide, N-methylacetamide, N-ethylacetamide, N,N-dimethylacetamide, or N,N-diethylacetamide, etc.

The organic solvent used for the hydrolysis and condensation can be used for forming a film after removing a specific organic solvent adversely affecting the coating properties, water, and by-products. In addition, according to its application, a secondary organic solvent can be added to the organic solvent and the combined solvent can be used for an organic solvent for forming a film; or a secondary organic solvent can be added, and a specific organic solvent, water, and by-products are removed, and then the combined solvent can be used for forming a film.

The present invention preferably uses a catalyst in order to facilitate hydrolysis and condensation. The catalyst used for hydrolysis and condensation is an acid catalyst or a base catalyst. The acid catalyst is not specifically limited, and the examples include chloric acid, nitric acid, sulfuric acid, phosphoric acid, fluoric acid, formic acid, acetic acid, propionic acid, butanoic acid, pentanoic acid, hexanoic acid, monochloroacetic acid, dichloroacetic acid, trichloroacetic acid, trifluoroacetic acid, oxalic acid, malonic acid, sulfonic acid, phthalic acid, fumaric acid, citric acid, maleic acid, oleic acid, methylmalonic acid, adipic acid, p-aminobenzoic acid, or p-toluenesulfonic acid, etc. The base catalyst is not specifically limited, but in case the formed insulating film is used for a semiconductor device, it does not suitably comprise metal ions that adversely affect a semiconductor device such as sodium, potassium, etc., and preferably ammonia water or an organic amine is used.

The organic amine is not specifically limited, and the examples include methylamine, ethylamine, propylamine, N,N-dimethylamine, trimethylamine, N,N-diethylamine, N,N-dipropylamine, tripropylamine, tetramethylammonium hydroxide, tetraethylammonium hydroxide, methylaminomethylamine, methylaminoethylamine, ethylaminomethylamine, ethylaminoethyl, methylalcoholamine, ethylalcoholamine, propanolamine, N-methylmethylalcoholamine, N-ethylmethylalcoholamine, N-methylethylalcoholamine, N-ethylethylalcoholamine, N,N-dimethylmethylalcoholamine, N,N-diethylmethylalcoholamine, N-methyldimethanolamine, N-ethyldimethanolamine, N-methyldiethanolamine, N-ethyldiethanolamine, methoxymethylamine, ethoxymethylamine, methoxyethylamine, ethoxyethylamine, aniline, diazabicycloundecene, pyridine, pyrrole, piperidine, chlorine, pyrrolidine, piperazine, etc.

In addition, in case an inorganic base is used, metal ions are completely removed from the composition after hydrolysis and condensation, and the composition is used for a coating composition. The acid catalyst or base catalyst can be used individually or in combination.

The added amount of the catalyst can be controlled according to reaction conditions, and it is preferable to use 0.00001 to 2 moles of the catalyst per 1 mole of silane compound. If the amount exceeds 2 moles per 1 mole of silane compound, reaction speed is very fast even at a low concentration and thus molecular weight control is difficult and gel is easily produced.

In the present invention, reactants can be hydrolyzed and condensed stepwise using an acid catalyst or a base catalyst. As examples, reactants can be hydrolyzed and condensed using an acid and then a base; or they can be hydrolyzed and condensed using a base and then an acid. In addition, after conducting a separate reaction respectively using an acid catalyst and a base catalyst, the condensates can be mixed.

In the present invention, water is added to hydrolyze a silane compound. The amount of water used in hydrolysis of a silane compound is preferably 1 mole or more pre 1 mole of silicon atoms of the silane compound, more preferably 1 to 50 moles, and most preferably 1.5 moles or more. If the water is added in an amount of less than 1 mole, hydrolysis and condensation do not sufficiently occur and mechanical properties of the resulting insulating film may be deteriorated. In addition, water can be added intermittently or continuously, and the catalyst may be pre-added in an organic solvent, or it can be added simultaneously while adding water, or it can be pre-dissolved or dispersed in water.

The reaction temperature for hydrolysis and condensation is preferably 0 to 100° C., and more preferably 15 to 80° C. The weight average molecular weight of the obtained hydrolysis-condensate is 500 or more, in polystyrene conversion molecular weight, and in case it is applied for an insulating film, it is preferably 500 to 1,000,000.

In order to further decrease the density of the obtained insulating film, the coating composition of the present invention may further comprises a pore-forming material. The pore-forming material, which can be thermally decomposed at 200 to 450° C., is selected from a group consisting of linear organic molecules or polymers, a cross-linked organic polymer, hyper-branched organic molecules or polymers, or dendrimers, etc., and in order to uniformly distribute pores with specific sizes in an insulating film, it preferably has compatibility with thermally decomposable organic substances contained in a silane compound. The pore-forming material is preferably contained in an amount of 1 to 60 wt % of the coating composition, and more preferably in an amount of 2 to 40 wt %.

The coating composition of the present invention for forming an insulating film may further comprises an additive such as colloidal silica, surfactant, etc., according to its use.

The composition of the present invention has a total solid content of 2 to 60 wt %, preferably 5 to 40 wt % considering film thickness and storage stability of an insulating film. The solid content can be controlled by the kind and amount of the organic solvent.

The composition of the present invention is coated on a substrate such as a silicon wafer, SiO₂ wafer, SiN wafer, semiconductor, etc. to form an insulating film. The insulating film can be formed by a spin coat method, an immersion method, a roll coat method, a spray method, etc., and a film with a specific thickness can be formed using these methods. Particularly, in case an interlayer insulating film for a multi-layered circuit of a semiconductor device is to be formed, a spin coat method is preferable.

The thickness of a film can be controlled by changing viscosity of the composition and rotation speed of a spin coater, and commonly, in case it is used for an interlayer insulating film for a multi-layered circuit of a semiconductor device, 0.1 to 2 μm is suitable.

After coating, a three dimensional organosilicate polymer insulating film is formed through drying and firing (curing) processes, and an organosilicate film can be further cured by a firing process. The drying process commonly includes pre-bake and soft-bake processes. During the pre-bake process, used organic solvent is gradually evaporated, and during the soft-bake process, some functional groups are cross-linked, and then, during the firing process, remaining functional groups are finally reacted. The drying process is preferably conducted at 30 to 200° C., and the firing process is preferably conducted at 200° C. or more, more preferably 200 to 500° C.

The drying and firing processes can be conducted while continuously elevating temperature at a specific speed, or they can be conducted intermittently. In case they are intermittently conducted, drying and firing are preferably conducted for 1 minute to 5 hours respectively. Heating can be conducted using a hot plate, an oven, a furnace, etc., and under an inert gas atmosphere such as with nitrogen, argon, helium, etc., under an oxygen atmosphere such as with an oxygen-containing gas (for example, air), under a vacuum, or under an ammonia or hydrogen-containing gas atmosphere. The drying and firing processes can use the same or different heating methods.

After drying and firing processes, if required, in order to minimize the amount of hydroxyl groups in an insulating film, surface-treatment can be conducted. Such a surface-treatment can be conducted using a silylated compound such as hexamethyldisilane, alkylalkoxysilane, or alkylacetoxysilane, etc.; or by firing under a reducing atmosphere such as hydrogen, or a fluorine-containing gas atmosphere. A silylation of an insulation film can be conducted by immersing or spin coating the film in a silylated compound or solvent-diluted silylated compound, or under vapor atmosphere of silylated compound. After silylation, the insulating film is preferably heated at 100 to 400° C.

The thus obtained film has superior insulating properties, uniformity, crack resistance, and surface strength, and thus it can be suitably used for an interlayer insulating film for a semiconductor device such as an LSI, system LSI, DRAM, SDRAM, RDRAM, D-RDRAM, etc., a protection film such as a surface coating film of a semiconductor device, an interlayer insulating film for a multi-layered wiring substrate, a protection film for a liquid crystal display, an insulation-preventing film, etc.

The present invention will be explained with reference to the following Examples, but these are to illustrate the present invention and the present invention is not limited to them.

### EXAMPLES

### Example 1

To a 250 mL round-bottom flask, 16 g of methyltrimethoxysilane and 7.16 g of tetramethoxy silane were dissolved in 24 g of propyleneglycol methylether acetate, and then 19.46 g of distilled water in which 514 mg of malonic acid was dissolved was added thereto while stirring with a stirrer. The temperature of the reactor was elevated to 60° C. and the reaction solution was reacted for 3 hours. Then the temperature was lowered to room temperature, and 2.08 g of distilled water and 6.4 g of propyleneglycol methylether acetate in which 4.26 g of bismethyldimethoxysilylpropyl polypropyleneoxide was dissolved were added. Then, the temperature of the solution was elevated to 60° C., the reaction solution was reacted for 20 hours, and then the temperature of the solution was lowered to room temperature. 70 g of propyleneglycol methylether acetate was added thereto, and 70 g of solvent comprising methylalcohol was evaporated from the reaction solution to obtain a coating composition for forming an insulating film.

### Example 2

A coating composition for forming an insulating film was obtained by the same method as in Examples 1, except that bistrimethoxysilylpropyl (polyethyleneoxide-b-polypropyleneoxide-b-polyethyleneoxide) was used instead of bismethyldimethoxysilylpropyl polypropyleneoxide.

### Example 3

A coating composition for forming an insulating film was obtained by the same method as in Examples 1, except that 3.72 g of distilled water and 11.4 g of a propyleneglycol methylether acetate solution in which 7.60 g of bismethyldimethoxysilylpropyl polypropyleneoxide was dissolved were further added, the temperature of the solution was elevated to 60° C., and the reaction solution was reacted for 20 hours, and then 80 g of propyleneglycol methylether acetate was added thereto, and 80 g of solvent comprising methylalcohol was evaporated from the reaction solution.

### Comparative Example 1

A coating composition for forming an insulating film was obtained by the same method as in Examples 1, except that bismethyldimethoxysilylpropyl polypropyleneoxide was not used.

### Comparative Example 2

A coating composition for forming an insulating film was obtained by the same method as in Examples 1, except that polypropyleneglycol was used instead of bismethyldimethoxysilylpropyl polypropyleneoxide.

(Preparation of an Insulation Film)

The solutions of coating compositions for forming an insulating film prepared in Examples 1 to 3 and Comparative Examples 1 and 2 were respectively spin-coated on silicon wafers to obtain thin films, and the films were cured at 250° C. for 1 hour and at 430° C. for 1 hour under a nitrogen atmosphere to prepare each insulation film.

The extinction of organic molecules from the prepared insulating films was identified by FTIR, the conditions of the cured films were observed with optical microscope and electron microscope, and changes in refractive indexes were measured by ellipsometry. The results are shown in the following Table 1.

TABLE 11

| | | | | Comparative | Comparative |
|---|---|---|---|---|---|
| | Example 1 | Example 2 | Example 3 | Example 1 | Example 2 |
| Conditions | Transparent | Transparent | Transparent | Transparent | Inferior coating |
| of insulating | film without | film without | film without | film | property |
| film | phase- | phase- | phase- | | (appearance |
| | separation | separation | separation | | of comb pattern) |
| Refractive | 1.295 | 1.297 | 1.225 | 1.385 | — |
| index (n) | | | | | |
| Dielectric | 2.18 | 2.21 | 1.89 | 2.85 | — |
| constant | | | | | |
| Modulus of | 3.5 | 3.4 | 1.8 | 8.2 | — |
| elasticity (Gpa) | | | | | |

Refractive index (n): measured at 632.8 nm.
Dielectric constant: measured by MIS method

As shown from the Table 1, the insulating films of the present invention prepared according to Examples 1 to 3 were transparent films without phase-separation, and they showed remarkably low refractive indexes compared to the insulating film of Comparative Example 1, indicating that they formed low-density films. In addition, the insulating films of Examples 1 to 3 to which organic molecules capped with silane compounds were applied according to the present invention showed superior coating properties compared to the insulating film of Comparative Example 2.

The organosilicate polymer prepared according to the present invention has superior thermal stability and mechanical strength. And, a composition for an insulating film comprising the same can be used for an interlayer insulating film for dielectric wiring that can contribute to a high-speed semiconductor device and reduce power consumption, and remarkably decrease cross-talk. In addition, a film obtained by applying the insulating film-forming composition to an insulating film has superior coating properties, it inhibits phase-separation, it can easily control minute pores because organic substances are thermally decomposed to form pores during the curing process, and it has superior insulating properties and remarkably reduced density.

What is claimed is:

1. A method for preparing an organosilicate polymer comprising the steps of mixing a thermally decomposable organic silane compound that is capped with silane compounds at both its ends, and a silane compound or a silane oligomer, and then adding water and a catalyst thereto to conduct hydrolysis and condensation.

2. The method for preparing an organosilicate polymer according to claim 1, wherein the thermally decomposable organic silane compound that is capped with silane compounds at both its ends are represented by the following Chemical Formula 1:
R¹ₚR²₃₋ₚSi-L—SiR³_{q}R⁴_{3-q} [Chemical Formula 1]
wherein
R¹ and R³ are independently a hydrogen, fluorine, aryl, vinyl, allyl, or linear or branched C1-4 alkyl unsubstituted or substituted with fluorine;
R² and R⁴ are independently an acetoxy, hydroxyl, or linear or branched C1-4 alkoxy;
L is an organic substance that can be thermally decomposed at 450° C. or less; and
p and q are respectively an integer of 0 to 2.

3. The method for preparing an organosilicate polymer according to claim 2, wherein the organic substance that can be thermally decomposed at 450° C. or less is selected from a group consisting of ether, ester, anhydride, carbonate, carbamate, acrylate, epoxy, isocyanate, and amide compounds.

4. The method for preparing an organosilicate polymer according to claim 1, wherein the silane compound or silane oligomer is comprised of silicone, carbon, oxygen, and hydrogen.

5. The method for preparing an organosilicate polymer according to claim 1, wherein the silane compound or silane oligomer is selected from a group consisting of compounds represented by the following Chemical Formula 2, Chemical Formula 3, and Chemical Formula 4:
SiR⁵ₓR⁶₄₋ₓ [Chemical Formula 2]
wherein
R⁵ is independently a hydrogen, fluorine, aryl, vinyl, allyl, or linear or branched C1-4 alkyl unsubstituted or substituted with fluorine;
R⁶ is independently an acetoxy, hydroxyl, or linear or branched C1-4 alkoxy; and
x is an integer of 0 to 2,
R⁷_{y}R⁸_{3-y}Si-M-SiR⁹_{z}R¹⁰_{3-z} [Chemical Formula 3]
wherein
R⁷ and R⁹ are independently a hydrogen, fluorine, aryl, vinyl, allyl, or linear or branched C1-4 alkyl unsubstituted or substituted with fluorine;
R⁸ and R¹⁰ are independently an acetoxy, hydroxyl, or linear or branched C-14 alkoxy;
M is C1-6 alkylene or phenylene; and
y and z are respectively an integer of 0 to 2,
[Chemical Formula 4] 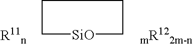
wherein
R¹¹ are independently a hydrogen, fluorine, aryl, vinyl, allyl, or linear or branched C1-4 alkyl unsubstituted or substituted with fluorine;
R¹² is independently a hydroxy, or a linear or branched C-14 alkoxy; and
m and n are respectively an integer of 3 to 10.

6. An organosilicate polymer prepared by mixing a thermally decomposable organic silane compound that is capped with silane compounds at both its ends, and a silane compound or silane oligomer, and then adding water and a catalyst to conduct hydrolysis and condensation.

7. A coating composition for forming an insulating film, which comprises:
a) an organosilicate polymer comprising
i) a thermally decomposable organic silane compound that is capped with silane compounds at both its ends, and
ii) a silane compound or silane oligomer; and
b) an organic solvent.

8. A method for manufacturing a low dielectric insulating film for a semiconductor device, which comprises the steps of:
a) providing a solution of a coating composition for forming an insulating film comprising:
i) an organosilicate polymer comprising a thermally decomposable organic silane compound that is capped with silane compounds at both its ends, and a silane compound or silane oligomer, and
ii) an organic solvent;
b) coating the a) solution on a substrate of a semiconductor device to form an insulating film; and
c) drying and firing the b) coated insulating film.

9. An insulating film for a semiconductor device prepared by the method of claim 8.

10. A semiconductor device comprising an insulating film for a semiconductor device prepared by the method of claim 8.
